(19) United States
(12) Patent Application Publication
(10) Pub. No.: US 2022/0298069 A1
(43) Pub. Date: Sep. 22, 2022

(54) STABILIZED GYPSUM PARTICLES

(71) Applicant: BASF SE, Ludwigshafen am Rhein (DE)

(72) Inventors: Maik SCHLESINGER, Ludwigshafen am Rhein (DE); Michael DIETZSCH, Ludwigshafen am Rhein (DE); Fabian NIEDERMAIR, Trostberg (DE); Uwe GEHRIG, Trostberg (DE); Torben GAEDT, Traunstein (DE); Christoph HESSE, Trostberg (DE)

(21) Appl. No.: 17/619,008

(22) PCT Filed: Jun. 8, 2020
(86) PCT No.: PCT/EP2020/065770

§ 371 Date: Dec. 14, 2021

(30) Foreign Application Priority Data
Jun. 14, 2019 (EP) 19180306.3

(51) Int. Cl. C04B 11/00; C04B 24/32

(52) U.S. Cl. CPC C04B 11/007; C04B 24/32; C04B 2103/408

(57) ABSTRACT

The present invention is directed to a construction chemical composition for the preparation of gypsum articles, said construction chemical composition comprising fine calcium sulfate and a dispersant being a polyarylether. Further the present invention is directed to a process for preparing said construction chemical composition as well as an article comprising said construction chemical composition.

The present invention is directed to a construction chemical composition for the preparation of gypsum based articles, said construction chemical composition comprising fine calcium sulfate and a dispersant being a polyarylether. Further the present invention is directed to a process for preparing said construction chemical composition as well as an article comprising said construction chemical composition.

Ground gypsum plays an important role within the gypsum wallboard production. The so-called ball-mill accelerator (BMA) is added as a seeding agent to initiate and finally shorten the gypsum hardening reaction. In combination with retarders, the addition of BMA is essential to obtain higher mechanical strength in a shorter time period of the final gypsum wallboards. However, the effect of BMA is rather limited due to its coarse and inhomogeneous particle size. In order to reduce the hardening time even further including an increase in mechanical performance, smaller particle sizes will be necessary. Such a material would probably enable higher production rates for gypsum wallboards, reduction of gypsum used or even gypsum wallboards with a better mechanical performance.

A conceivable alternative beside grinding is given by precipitation starting from soluble calcium and sulfate sources. US 2015114268 relates to a process for producing calcium sulphate dihydrate by reacting a water-soluble calcium compound with a water-soluble sulphate compound in the presence of water and a polymer containing acid groups and polyether groups. Additionally disclosed are calcium sulphate dihydrate producible by this process, and the use thereof for production of gypsum plasterboard. A disadvantage of the precipitation starting from soluble calcium and sulfate sources are the relatively high cost of the starting materials and complex process control, which leads to overall high production costs of the final product.

A further approach to refine the particle size of ground gypsum is the application of polymeric dispersants in the wet-grinding process. U.S. Pat. No. 7,861,955 discloses wet-grinding of gypsum using polycarboxylate dispersants as stabilizers to reduce the mean particle size of gypsum at high solid contents. However, the application of the resulting gypsum particles does not lead to satisfying acceleration rates of the gypsum formation. Polycarboxylate dispersants in general have a retarding effect on gypsum formation and thus work contrary to fine gypsum particle accelerators.

Accordingly, there is a need in the art for a construction chemical composition, which is suitable as a setting accelerator for gypsum containing compositions and especially gypsum plaster boards without the above described disadvantages of the prior art.

Therefore, it is an object of the present invention to provide a construction chemical composition, which is suitable as setting accelerator for gypsum compositions featured by an accelerated gypsum hardening reaction. Further, the mechanical properties of the resulting gypsum article should be further improved. It was therefore a further object of the present invention to obtain higher compressive strength in a shorter time period of the prepared gypsum article, which is important for the production, transportation and handling.

The foregoing and other objects are solved by the subject-matter of the present invention.

According to a first aspect of the present invention, a construction chemical composition is provided, comprising
i) fine calcium sulfate particles having a D (0.63) particle size of less than 10.0 μm determined with laser diffraction (Mastersizer 2000 from Malvern Instruments) according to Mie Theory for small particles (Particle RI=1.531, Dispersant RI=1,.330; Absorption=0.1; Obscuration between 10 and 20%), and
ii) a dispersant being a polyarylether,

wherein the weight ratio between the fine calcium sulfate particles and the dispersant is in the range of 0.1:99.9 to 99.9:0.1.

According to one embodiment of the present invention, the fine calcium sulfate particles are present in the form of calcium sulfate hemihydrate (mineral name:basanite), calcium sulfate dihydrate (mineral name: gypsum), anhydrous calcium sulfate (mineral name:anhydrite) or mixtures thereof.

According to another embodiment of the present invention, the polyarylether is a polycondensation product comprising
i) at least one aromatic or heteroaromatic structural unit comprising a polyether side chain, and
ii) at least one phosphated aromatic or heteroaromatic structural unit.

It is especially preferred that

the at least one aromatic or heteroaromatic structural unit comprising a polyether side chain is represented by formula (I)

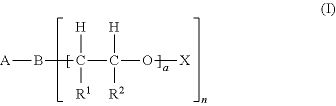

wherein

A are identical or different and are represented by a substituted or unsubstituted aromatic or heteroaromatic compound having 5 to 10 C atoms;

B are identical or different and are represented by N, NH or O;

n=2 if B=N and n=1 if B=NH or O;

R¹ and R², independently of one another, are identical or different and are represented by a branched or straight-chain C1- to C10-alkyl radical, C5- to C8-cycloalkyl radical, aryl radical, heteroaryl radical or H;

a are identical or different and are represented by an integer from 1 to 300, preferably 10 to 60, more preferably 20 to 50; and

X are identical or different and are represented by a branched or straight-chain C1- to C10-alkyl radical, C5- to C8-cycloalkyl radical, aryl radical, heteroaryl radical or H, and that

the at least one phosphated aromatic or heteroaromatic structural unit is represented by formula (II)

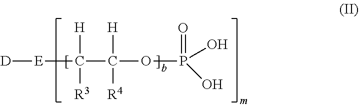

wherein

D are identical or different and are represented by a substituted or unsubstituted aromatic or heteroaromatic compound having 5 to 10 C atoms;

E are identical or different and are represented by N, NH or O;

m=2 if E=N and m=1 if E=NH or O;

R³ and R⁴, independently of one another, are identical or different and are represented by a branched or straight-chain C1- to C10-alkyl radical, C5- to C8-cycloalkyl radical, aryl radical, heteroaryl radical or H; and

b are identical or different and are represented by an integer from 0 to 300.

The construction chemical composition may further include a defoamer to reduce the amount of foaming or gas bubbles produced during the preparation process. Any defoamer suitable for use within aqueous polyarylether dispersant containing systems may be used. Suitable examples of defoamers which may be used include but are not limited to silicone defoamers, mineral oil/silica defoamers, low surface tension additives and mixtures thereof. Examples of silicone defoamers which may be used include but are not limited to polysiloxane solutions and non-aqueous emulsions of polysiloxanes. Examples of polysiloxane solutions which may be used as a defoamer include but are not limited to a cyclohexanone polysiloxane solution, a diisobutylketone polysiloxane solution and mixtures thereof. An example of a non-aqueous polysiloxane emulsion which may be used as a defoamer is a polysiloxane propylene glycol emulsion. In certain embodiments, the defoamer is a diisobutylketone polysiloxane solution commercially available from BYK Chemie GmbH (Wesel, Germany) under the trademarks BYK®-066N, BYK®-070, BYK®-077, BYK®-A500. Further suitable examples of defoamers are kerosene, liquid paraffin, animal oil, vegetable oil, sesame oil, castor oil, alkylene oxide adducts thereof, oleic acid, stearic acid and alkylene oxide adducts thereof, diethylene glycol laurate, glycerin monorecinolate, alkenyl succinic acid derivatives, sorbitol monolaurate, sorbitol trioleate, polyoxyethylene monolaurate, polyoxyethylene sorbitol monolaurate, natural wax, linear or branched fatty alcohols and their alkoxylated derivatives, octyl alcohol, hexadecyl alcohol, acetylene alcohol, glycols, polyoxyalkylene glycol, polyoxyalkylene amide, acrylate polyamine, tributyl phosphate, sodium octyl phosphate; aluminum stearate, calcium oleate, silicone oil, silicone paste, silicone emulsion, tiuorosilicone oil; and polyoxyethylene polyoxypropylene adducts. In a preferred embodiment, the defoamer is polyoxyethylene polyoxypropylene adducts. The amount of defoamer used within the construction chemical composition may range from about 0.002 to about 10 percent by weight of the polyarylether dispersant.

The present invention is further directed to a process for the preparation of a construction chemical composition comprising fine calcium sulfate having a D (0.63) particle size of less than 10.0 μm determined with laser diffraction according to Mie Theory and a dispersant being a polyarylether, said process comprising the steps of
aa) providing a suspension comprising calcium sulfate particles having a D (0.63) particle size equal or above 10.0 μm determined with laser diffraction according to Mie Theory, water and a dispersant being a polyarylether, and
ab) wet-grinding of the suspension obtained in step aa), thereby obtaining the construction chemical composition,

wherein the weight ratio between the fine calcium sulfate particles and the dispersant is in the range of 0.1:99.9 to 99.9:0.1.

According to one embodiment of the present invention, the calcium sulfate particles are present in the form of calcium sulfate hemihydrate (mineral name: basanite), calcium sulfate dihydrate (mineral name: gypsum), anhydrous calcium sulfate (mineral name: anhydrite) or mixtures thereof.

It is preferred that the calcium sulfate particles are present in the form of calcium sulfate hemihydrate (mineral name: basanite), calcium sulfate dihydrate (mineral name: gypsum), or mixtures thereof.

It is preferred that the polyarylether is a polycondensation product as defined above.

According to one embodiment of the present invention, the suspension of step aa) has a solid content in the range of 6.0 to 75.0 wt.-%.

The solid content is defined as the ratio of the residual weight of the sample after drying at 40° C. until constant weight in relation to the initial weight of the sample before heating up.

According to another embodiment of the present invention, the weight ratio between the calcium sulfate particles and the dispersant in the suspension of step aa) is in the range of 1.0 to 200.

According to a further embodiment of the present invention, the suspension of step aa) comprises
i) 5.0 to 70.0 wt.-% of calcium sulfate particles,
ii) 0.01 to 10.0 wt.-% of the dispersant being a polyarylether, and
iii) the balance to 100 wt.-% being water, based on the overall weight of the suspension.

According to one embodiment of the present invention, the wet-grinding according to step ab) is carried out in a ball mill, a rotary grinder or an agitator bead mill.

According to another embodiment of the present invention, the process further comprises a step ac) wherein the construction chemical composition obtained in step ab) is dried, thereby obtaining the construction chemical composition in powder form.

The present invention is further directed to a process for the preparation of a construction chemical composition comprising fine calcium sulfate having a D (0.63) particle size of less than 10.0 μm determined with laser diffraction according to Mie Theory and a dispersant being a polyarylether, said process comprising the steps of
ba) providing a liquid A comprising a calcium source, water and a dispersant being a polyarylether,
bb) providing a liquid B comprising a sulfate source, water and optionally a dispersant being a polyarylether, and
bc) precipitation of fine calcium sulfate by mixing liquid A and liquid B, thereby obtaining the construction chemical composition, wherein the weight ratio between the fine calcium sulfate particles and the dispersant is in the range of 0.1:99.9 to 99.9:0.1.

The calcium source in liquid A is selected from the group consisting of calcium acetate, calcium chloride, calcium hydroxide, calcium nitrate, calcium oxide, calcium sulfamate, calcium thiocyanate, or mixtures thereof.

The sulfate source in liquid B is selected from the group consisting of aluminum sulfate, potassium sulfate, sodium sulfate, sulfuric acid or mixtures thereof, in which the different hydrates of the sulfates named are included.

It is preferred that the polyarylether is a polycondensation product as defined above.

According to another embodiment of the present invention, the precipitation according to step bc) is carried out in a continuous microreactor or a spray precipitation reactor.

According to another embodiment of the present invention, the process further comprises a step bd) wherein the construction chemical composition obtained in step bc) is dried, thereby obtaining the construction chemical composition in powder form.

The present invention is also directed to a construction chemical composition obtained by the processes as described above.

Further, the present invention is directed to the use of a construction chemical composition as described above in a process for preparing a gypsum wallboard, said process comprising the steps of
a) providing a composition comprising gypsum, preferably calcium sulfate hemihydrate (mineral name: basanite), mixing water and optionally foam,
b) feeding the composition obtained in step a) into a mixing device, thereby preparing a slurry,
c) applying the slurry obtained in step b) to a first cardboard sheet, and
d) covering the slurry with a second cardboard sheet,

wherein
i) at least one of the mixing water and the foam contains the construction chemical composition according to this invention, and/or
ii) the first cardboard sheet and/or the second cardboard sheet is coated with the construction chemical composition according to this invention, and/or
iii) the construction chemical composition according to this invention is added to the slurry in the mixing device or through a feed valve at the outlet of the mixing device.

The present invention is further directed to the use of a polyarylether as a dispersant in a wet-grinding or precipitation process for the preparation of fine calcium sulfate.

It is especially preferred that the polyarylether is a polycondensation product as described above.

The present invention is further directed to an article, comprising the above described construction chemical composition.

Preferably, the article is a gypsum wallboard or a non-woven gypsum board.

In the following, the present invention is described in more detail.

The construction chemical composition

The present invention is directed to a construction chemical composition, comprising
i) fine calcium sulfate particles having a D (0.63) particle size of less than 10.0 μm determined with laser diffraction according to Mie Theory, and
ii) a dispersant being a polyarylether, wherein the weight ratio between fine calcium sulfate particles and the dispersant is in the range of 0.1:99.9 to 99.9:0.1.

It is preferred that the fine calcium sulfate particles are present in the form of calcium sulfate hemihydrate (mineral name: basanite), calcium sulfate dihydrate (mineral name: gypsum), anhydrous calcium sulfate (mineral name: anhydrite) or mixtures thereof.

The term “gypsum” as used herein is used colloquially both for the compound calcium sulphate dihydrate (CaSO₄·2H₂O) and for the rock consisting of this compound, and the corresponding building material, calcium sulphate hemihydrate (CaSO₄·0.5H₂O or bassanite) or anhydrous calcium sulfate (CaSO₄ or anhydrite). Unless indicated otherwise, the term “gypsum” as used herein is related to the compound calcium sulfate in its water-free or hydrated form.

Gypsum (CaSO₄·2H₂O) occurs naturally in large deposits, which formed when oceans dried out in the Earth's history. In addition, gypsum (CaSO₄·2H₂O) is obtained as a product or by-product of various processes in industry, an example being flue gas desulphurization, where sulphur dioxide is depleted from the combustion off-gases of coal-fired power plants by means of a calcium carbonate or calcium hydroxide slurry.

When heated to temperatures of 120-130° C., the calcium sulphate dihydrate releases part of its water of crystallization, and converts into calcium sulfate hemihydrate (CaSO₄·0.5H₂O or bassanite). If calcium sulfate hemihydrate is mixed with water, calcium sulfate dihydrate is reformed within a short time.

Calcium sulphate hemihydrate (bassanite) is an important building material for the production of mortars, screeds, casting moulds and, in particular, gypsum plasterboard. Owing to technical requirements, qualities which vary considerably are required of calcium sulphate binders. Particularly with regard to processing life and the time at which stiffening occurs, the binders must be variably adjustable over a period from a few minutes to several hours. In order to satisfy these requirements, the use of admixtures that regulate hardening is a necessity.

A further component of the construction chemical composition according to the invention is a dispersant being a polyarylether.

As used herein, the term “polyarylether” is related to a polymeric compound comprising aryl moieties and ether moieties.

In particular, it is preferred that the polyarylether according to the present invention is a polycondensation product comprising
i) at least one aromatic or heteroaromatic structural unit comprising one or more polyether side chain(s), and
ii) at least one phosphated aromatic or heteroaromatic structural unit.

Preferably, said aromatic or heteroaromatic structural unit comprising one or more polyether side chain(s) comprises one or more polyalkylene glycol side chain(s), more preferably one or more polyethylene glycol side chain(s). In particular, it is preferred that the aromatic or heteroaromatic structural unit comprising one or more polyether side chain(s), preferably one or more polyalkylene glycol side chain(s), is selected from the group consisting of alkoxylated, more preferably ethoxylated hydroxyl-functionalized aromatic or heteroaromatic compounds. For example, said hydroxyl-functionalized aromatic or heteroaromatic compounds are selected from phenoxyethanol, phenoxypropanol, 2-alkoxyphenoxyethanol, 4-alkoxyphenoxyethanol, 2-alkylphenoxyethanol, 4-alkylphenoxyethanol or mixtures thereof. Further preferred aromatic or heteroaromatic structural unit comprising one or more polyether side chain(s), preferably one or more polyalkylene glycol side chain(s) are alkoxylated, preferably ethoxylated amino-functionalized aromatic or heteroaromatic compounds such as N,N-(dihydroxyethyl)aniline, N-(hydroxyethyl)aniline, (dihydroxypropyl)aniline, N-(hydroxypropyl)aniline or mixtures thereof. Even more preferred are alkoxylated phenol derivatives such as phenoxyethanol and/or phenoxypropanol. Particularly preferred are alkoxylated, more preferably ethoxylated phenol derivatives having a weight molecular weight M_{w} in the range of 300 to 10 000 Dalton, for example polyethyleneglycol monophenylether.

As outlined above, the inventive polyarylether being a polycondensation product further comprises at least one phosphated aromatic or heteroaromatic structural unit. Thus, without being bound to theory, the polyarylether has a certain acidity based on the presence of said phosphated aromatic or heteroaromatic structural unit. The phosphated aromatic or heteroaromatic structural unit is obtainable by phosphating of the corresponding alcohols with polyphosphoric acid and/or phosphorous pentoxide according to methods known in the art.

Preferably, the phosphated aromatic or heteroaromatic structural unit is selected from the group of alkoxylated, preferably ethoxylated hydroxyl-functionalized aromatic or heteroartomatic compounds comprising at least one phosphoric ester group such as phenoxyethanolphosphate and/or poly(ethylenglycol)monophenylether phosphate and/or alkoxylated, preferably ethoxylated amino-functionalized aromatic or heteroaromatic compounds comprising at least one phosphoric ester group such as N,N-(dihydroxyethyl)anilin diphosphate, N,N-(dihydroxyethyl)aniline phosphate, N-(hydroxypropyl)aniline phosphate, N,N-(dihydroxyethyl)aniline phosphate, N-(hydroxypropyl)aniline phosphate or mixtures thereof. Even more preferred are alkoxylated, more preferably ethoxylated phenol derivatives comprising at least one phosphoric ester group such as polyethyleneglycol monophenylether phosphate.

Further, it is preferred that the inventive polyarylether being a condensation product has a weight molecular weight M_{w} in the range of 4000 to 150 000 Dalton, more preferably 10 000 to 100 000 Dalton, still more preferably 15 000 to 75 000 Dalton. The weight molecular weight M_{w} is determined by size exclusion chromatography (column combination: OH-Pak SB-G, OH-Pak SB 804 and OH-Pak SB 802.5 HQ by Shodex, Japan; Eluent: 80 vol.-% aqueous solution of HCO₂NH₄ (0.05 mol/L) and 20 vol.-% aceto nitrile; Injection volume 100 pL, throughput rate 0.5 mL/min). For the calibration for determining the weight molecular weight M_{w}, a linear poly(ethyleneoxide)- and polyethyleneglycol standard was used.

It is especially preferred that the at least one aromatic or heteroaromatic structural unit comprising a polyether side chain is represented by formula (I)

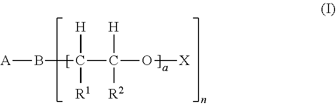

wherein

A are identical or different and are represented by a substituted or unsubstituted aromatic or heteroaromatic compound having 5 to 10 C atoms;

B are identical or different and are represented by N, NH or O;

n=2 if B=N and n=1 if B=NH or O;

R¹ and R², independently of one another, are identical or different and are represented by a branched or straight-chain C1- to C10-alkyl radical, C5- to C8-cycloalkyl radical, aryl radical, heteroaryl radical or H;

a are identical or different and are represented by an integer from 1 to 300; and

X are identical or different and are represented by a branched or straight-chain C1- to C10-alkyl radical, C5- to C8-cycloalkyl radical, aryl radical, heteroaryl radical or H, and that

the at least one phosphated aromatic or heteroaromatic structural unit is represented by formula (II)

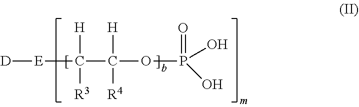

wherein

D are identical or different and are represented by a substituted or unsubstituted aromatic or heteroaromatic compound having 5 to 10 C atoms;

E are identical or different and are represented by N, NH or O;

m=2 if E=N and m=1 if E=NH or O;

R³ and R⁴, independently of one another, are identical or different and are represented by a branched or straight-chain C1- to C10-alkyl radical, C5- to C8-cycloalkyl radical, aryl radical, heteroaryl radical or H; and

b are identical or different and are represented by an integer from 0 to 300.

More preferably, the at least one aromatic or heteroaromatic structural unit comprising a polyether side chain is represented by formula (I) as defined above, wherein A are identical or different and are represented by a substituted or unsubstituted aromatic compound having 5 to 10 C atoms;

B is represented by O;

n=1;

R¹ and R², independently of one another, are identical or different and are represented by a branched or straight-chain C1- to C5-alkyl radical or H;

a are identical or different and are represented by an integer from 1 to 300; and

X are identical or different and are represented by a branched or straight-chain C1- to C10-alkyl radical, aryl radical, or H,

and that

the at least one phosphated aromatic or heteroaromatic structural unit is represented by formula (II) as defined above, wherein

D are identical or different and are represented by a substituted or unsubstituted aromatic compound having 5 to 10 C atoms;

E is represented by O;

m=1;

R³ and R⁴, independently of one another, are identical or different and are represented by a branched or straight-chain C1- to C10-alkyl radical, aryl radical, or H; and

b are identical or different and are represented by an integer from 0 to 300.

Even more preferably, the at least one aromatic or heteroaromatic structural unit comprising a polyether side chain is represented by formula (I) as defined above, wherein

A are identical or different and are represented by an unsubstituted aromatic compound having 5 to 10 C atoms;

B is represented by O;

n=1;

R¹ and R², independently from each other, are represented by methyl or H;

a are identical or different and are represented by an integer from 1 to 300; and

X are represented by H, and that

the at least one phosphated aromatic or heteroaromatic structural unit is represented by formula (II) as defined above, wherein

D are identical or different and are represented by an unsubstituted aromatic compound having 5 to 10 C atoms;

E is represented by O;

m=1;

R³ and R⁴, independently from each other, are represented by methyl or H; and

b are identical or different and are represented by an integer from 0 to 300.

Still more preferably, the at least one aromatic or heteroaromatic structural unit comprising a polyether side chain is represented by formula (I) as defined above, wherein A is represented by phenyl;

B is represented by O;

n=1;

R¹ and R² are represented by H;

a are identical or different and are represented by an integer from 1 to 300; and

X are represented by H,

and that

the at least one phosphated aromatic or heteroaromatic structural unit is represented by formula (II) as defined above, wherein

D is represented by phenyl;

E is represented by O;

m=1;

R³ and R⁴ are represented by H; and

b are identical or different and are represented by an integer from 0 to 300.

According to a preferred embodiment of the present invention, the polyarylether comprises a further structural unit represented by formula (III)

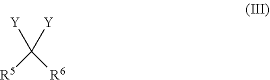

wherein

Y, independently from each other, are identical or different and are represented by formula (I) or (II) as described above, and

R⁵ and R⁶, independently from each other, are identical or different and are represented by H, methyl, COOH or a substituted or unsubstituted aromatic or heteroaromatic compound having 5 to 10 C atoms.

More preferably, said further structural unit is represented by formula (III) as described above, wherein

Y, independently from each other, are identical or different and are represented by formula (I) or (II) as described above, and

R⁵ and R⁶, independently from each other, are identical or different and are represented by H, methyl or phenyl.

Even more preferably, said further structural unit is represented by formula (III) as described above, wherein

Y, independently from each other, are identical or different and are represented by formula (I) or (II) as described above, and

R⁵ and R⁶ are represented by H.

The molar ratio between the structural units (I), (II) and (III) within the polyarylether (III):RI)+[(II)] is preferably in the range of 1:0.5 to 2.0, more preferably in the range of 1:0.9 to 2.0. The molar ratio between the structural units (I) and (II) within the polyarylether (I):(II) is preferably in the range of 1:10 to 10:1, more preferably in the range of 1:5 to 3:1.

The polyarylethers suitable for the inventive wet-grinding process are obtainable by methods known in the art. For instance, a process for the preparation of said polyarylethers is described in WO 2010/040611 A1.

Preferably, the weight ratio between the fine calcium sulfate particles and the dispersant within the inventive construction chemical composition is in the range of 0.1:99.9 to 99.9:0.1, more preferably in the range of 60.0:40.0 to 99.0 to 1.0, still more preferably in the range of 50.0:50.0 to 99.0:1.0, yet more preferably in the range of 80.0:20.0 to 98.0 to 2.0, like in the range of 85.0:15.0 to 99.9:0.1. It is especially preferred that the weight ratio between the fine calcium sulfate particles and the dispersant is in the range of 85.0:15.0 to 99.9:0.1.

Further, it is preferred that the construction chemical composition according to the invention is a liquid construction chemical composition, more preferably an aqueous construction chemical composition.

Accordingly, a further component of the construction chemical composition is water.

Therefore, it is preferred that the construction chemical composition comprises
i) 0.07 to 70.0 wt.-%, more preferably 5.0 to 60.0 wt.-%, still more preferably 10.0 to 60.0 wt.-%, still more preferably 15.0 to 45 wt.-%, yet more preferably 20.0 to 35.0 wt.-% of fine calcium sulfate particles,
ii) 0.07 to 70.0 wt.-%, more preferably 0.1 to 40.0 wt.-%, still more preferably 0.1 to 5.0 wt.-%, yet more preferably 0.5 to 3.0 wt.-% of the dispersant being a polyarylether, and
iii) the balance to 100 wt.-% being water,

based on the overall weight of the construction chemical composition.

Next to the above described polyarylether, the construction chemical composition may comprise further dispersants other than polyarylethers. Preferably, the slurry according to step aa), ba) or bb) comprises at least one dispersant other than polyarylethers. Non-limiting examples for such dispersants are cationic polymers, polyamines, polyamides, polycondensates containing sulfonic acids, ketone resins or mixtures thereof.

Hence, according to a preferred embodiment of the present invention, the construction chemical composition further comprises a dispersant selected from the group consisting of cationic polymers, polyamines, polyamides, polycondensates containing sulfonic acid, ketone resins, or mixtures thereof.

As used herein, the term “cationic polymer” is related to a polymer having cationic groups in the main chain or as side chains.

Non-limiting examples for suitable cationic poiymers are cationic copolymers, comprising 3 to 97 mol-% of a cationic structural unit of formula (IV)

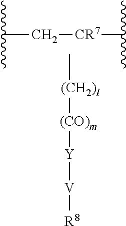

wherein

R⁷ in each occurrence is the same or different and represents hydrogen and/or methyl,

R⁸ in each occurrence is the same or different and contains a quaternary amine, pyridinium or pyrrazole cation, preferably selected from the group consisting of:

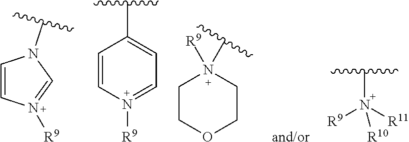

wherein

R⁹, Rw and R¹¹ in each occurrence are the same or different and each independently represent hydrogen, an aliphatic hydrocarbon moiety having 1 to 20 carbon atoms, a cycloaliphatic hydrocarbon moiety having 5 to 8 carbon atoms, aryl having 6 to 14 carbon atoms and/or a polyethylene glycol (PEG) moiety,

l in each occurrence is the same or different and represents an integer from 0 to 2,

m in each occurrence is the same or different and represents 0 or 1,

n in each occurrence is the same or different and represents an integer from 1 to 10,

Y in each occurrence is the same or different and represents an absent group, oxygen, NH and/or N R⁹,

V in each occurrence is the same or different and represents

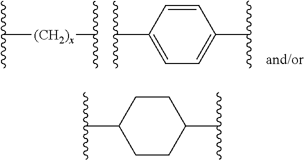

wherein

x in each occurrence is the same or different and represents an integer from 0 to 6, and

X in each occurrence is the same or different and represents a halogen atom, a C1-4-alkyl sulfate, a C1-4-alkyl sulfonate, a C6-14-(alk)aryl sulfonate and/or a monovalent equivalent of a polyvalent anion, which is selected from a sulfate, a disulfate, a phosphate, a diphosphate, a triphosphate and/or a polyphosphate.

Examples for said cationic polymers are described in US 2016/0369024.

As used herein, the term “polyamine” is related to a polymer containing amine moieties in the main chain. Preferably, said polyamine is polyalkyleneamine which is unsubsituted or substituted with one or more alkyl or hydroxyl groups. It is especially preferred that the polyamine is a compound of formula (V),

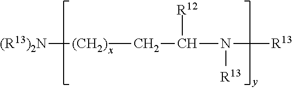

wherein

x in each occurrence is 0 to 4, more preferably 0 to 2, still more preferably 0,

y in each occurrence is 1, 2 or 3,

R¹² in each occurrence is H or CH₃, more preferably H, and

R¹³ in each occurrence is hydrogen, hydroxyl or linear or branched C₁ to C₅-alkyl optionally substituted with hydroxyl.

As used herein, the term “polycondensates containing sulfonic acid” refers to polymeric dispersants containing sulfonic acid groups obtained by polycondensation. Non-limiting examples for suitable polycondensates containing sulfonic acid are beta-naphthalenesulfonate-formaldehyde condensates (BNS), sulfonated melamine-formaldehyde condensates or acetone-formaldehyde condensates.

As used herein, the term “ketone resin” is related to a monomer-based condensation product wherein the monomers comprise at least a ketone (I) and formaldehyde (II). Preferably, said condensation product further comprises at least one moiety (111) selected from the group consisting of phosphono, sulfite, sulphino, sulphamido, sulphoxy, sulphoalkyloxy, sulphinoalkyloxy, phophonooxy and/or salts thereof, wherein alkyl may be selected from any branched or unbranched C1-C10-alkyl. Typically, the monomer ratio (I)/(11)/(111) is 1/2-3/0.33-1.

It is especially preferred that said ketone resin is prepared from cyclohexanone and/or acetone, formaldehyde and sulfite, more preferably cyclohexanone, formaldehyde and sulfite as the monomers.

Preferably, the ketone resin has a molecular weight between 10 000 and 40 000 g/mol, more preferably between 15 000 and 25 000 g/mol.

Suitable ketone resins are, for instance, described in US 2016/0229748.

Preferably, the construction chemical composition according to the invention comprises 0.01 to 10.0 wt.-%, more preferably 0.1 to 6.0 wt.-%, still more preferably 1.0 to 3.0 wt.-% of the least one dispersant other than polyarylethers, based on the overall weight of the construction chemical composition.

The construction chemical composition may further comprise a stabilizer.

As used herein, the term “stabilizer” is related to an additive which increases the shelf life of a liquid construction chemical composition. Non-limiting examples for stabilizers are oligosaccharides and polysaccharides, preferably starch ethers, welan gum, diutan gum, xanthan, chitosan, guar derivatives or mixtures thereof.

Preferably, the construction chemical composition comprises 0.01 to 8.0 wt.-%, more preferably 0.1 to 5.0 wt.-%, still more preferably 0.2 to 2.0 wt.-% of the stabilizer, based on the overall weight of the slurry.

Further, the construction chemical composition may be modified by the presence of additives. Typically, a gypsum slurry contains additives affecting the flow properties or the hardening process. For example, the slurry may comprise one or more additives selected from the group consisting of cellulose ethers, hydrated lime, mineral additives, aggregates of low density, fibers, accelerators, thickening agents, retarders, air-entraining agents, foaming agents, swelling agents, fillers, polyacrylates, dispersants, superabsorbers and stabilizers.

Therefore, it is preferred that the construction chemical composition comprises, more preferably consists of,
i) 0.07 to 70.0 wt.-%, more preferably 15.0 to 60.0 wt.-%, still more preferably 20.0 to 45 wt.-% of gypsum,
ii) 0.01 to 10.0 wt.-%, more preferably 0.1 to 5.0 wt.-%, still more preferably 0.5 to 3.0 wt.-% of the dispersant being a polyarylether,
iii) optionally 0.01 to 9.0 wt.-%, more preferably 0.1 to 6.0 wt.-%, still more preferably 1.0 to 3.0 wt.-% of the least one dispersant other than polyarylethers,
iv) optionally 0.01 to 7.0 wt.-%, more preferably 0.1 to 5.0 wt.-%, still more preferably 0.2 to 2.0 wt.-% of the stabilizer,
v) optionally up to 4.0 wt.-%, more preferably 0.01 to 3.0 wt.-%, still more preferably 0.1 to 2.0 wt.-% of additives, and
vi) the balance to 100 wt.-% being water,

based on the overall weight of the construction chemical composition.

Preferably, the construction chemical composition may comprise retarders and/or accelerators.

As used herein, the term “retarder” is related to an additive which retards the hydration of calcium sulfate hemihydrate (basanite) or anhydrous calcium (anhydrite) sulfate under formation of calcium sulfate dihydrate (gypsum). Non-limiting examples for retarders are fruit acids like (e.g. tartaric acid, citric acid) and salts thereof, gluconates, protein hydrolysates, polycondensates of amino acids, phosphates¹, phosphonates, complexing agents, hydroxycarboxylic acids, saccharides, organo phosphates and mixtures thereof.

As used herein, the term “accelerator” is related to an additive which accelerates the hydration of calcium sulfate hemihydrate (basanite) or anhydrous calcium (anhydrite) sulfate under formation of calcium sulfate dihydrate (gypsum). Non-limiting examples for accelerants are K₂SO₄ as well as finely ground dihydrate.

The process

As outlined above, the process according to the present invention comprises the steps of
aa) providing a suspension comprising calcium sulfate particles having a D (0.63) particle size equal or above 10.0 μm determined with laser diffraction according to Mie Theory, water and a dispersant being a polyarylether, and
ab) wet-grinding of the suspension obtained in step aa), thereby obtaining the construction chemical composition,

wherein the weight ratio between the fine calcium sulfate particles and the dispersant is in the range of 0.1:99.9 to 99.9:0.1.

According to step aa) of the inventive process, a suspension comprising gypsum, water and a dispersant being a polyarylether is provided.

Regarding the term gypsum, reference is made to the definition provided above. According to the present invention, either natural gypsum or synthetic gypsum is used. Natural gypsum requires no physical or chemical treatment to render it useful in the intended applications.

Regarding the term polyarylether, reference is made to the definition provided above as well. It is preferred that the polyarylether is a polycondensation product as described above.

Preferably, the initial particle size of the gypsum, i.e. the particle size before the wet-grinding step ab), is in the range of 10.0 to 250.0 μm, more preferably in the range of 15.0 to 200.0 μm, still more preferably 20.0 to 150.0 μm, determined according to D (0.63) measured with laser diffraction according to Mie Theory.

According to a preferred embodiment of the present invention, the suspension of step aa) has a solid content in the range of 6.0 to 75.0 wt.-%, more preferably 20.0 to 65.0 wt.-%, still more preferably in the range of 30.0 to 60.0 wt.-%, like in the range of 35.0 to 50.0 wt.-%.

A further component of the suspension according to step aa) of the inventive process is water.

Accordingly, it is preferred that the suspension according to step aa) comprises
i) 0.07 to 70.0 wt.-%, more preferably 5.0¹t⁷o 60.0 wt.-%, still more preferably 10.0 to 60.0 wt.-%, still more preferably 15.0 to 45 wt.-%, yet more preferably 20.0 to 35.0 wt.-% of fine calcium sulfate particles,
ii) 0.07 to 70.0 wt.-%, more preferably 0.1 to 40.0 wt.-%, still more preferably 0.1 to 5.0 wt.-%, yet more preferably 0.5 to 3.0 wt.-% of the dispersant being a polyarylether, and
iii) the balance to 100 wt.-% being water, based on the overall weight of the suspension.

Further, the suspension according to step aa) may comprise a dispersant other than polyarylethers selected from the group consisting of cationic polymers, polyamines, polyamides, polycondensates containing sulfonic acid, ketone resins, or mixtures thereof as described above.

The suspension according to step aa) may also comprise a stabilizer as described above and/or further additives.

Therefore, it is preferred that the suspension according to step aa) comprises, more preferably consists of
i) 0.07 to 70.0 wt.-%, more preferably 15.0 to 60.0 wt.-%, still more preferably 20.0 to 45 wt.-% of gypsum,
ii) 0.01 to 10.0 wt.-%, more preferably 0.1 to 5.0 wt.-%, still more preferably 0.5 to 3.0 wt.-% of the dispersant being a polyarylether,
iii) optionally 0.01 to 9.0 wt.-%, more preferably 0.1 to 6.0 wt.-%, still more preferably 1.0 to 3.0 wt.-% of the least one dispersant other than polyarylethers,
iv) optionally 0.01 to 7.0 wt.-%, more preferably 0.1 to 5.0 wt.-%, still more preferably 0.2 to 2.0 wt.-% of the stabilizer,
v) optionally up to 4.0 wt.-%, more preferably 0.01 to 3.0 wt.-%, still more preferably 0.1 to 2.0 wt.-% of additives, and
iii) the balance to 100 wt.-% being water,

based on the overall weight of the supension.

According to step ab) of the inventive process, the slurry obtained in step aa) is exposed to a wet-grinding process in order to obtain fine calcium sulfate particles.

The suspension according to step aa) is ground by any known grinding or comminution apparatus. Non-limiting examples of suitable grinding devices include ball mills, rotary grinders, agitator bead mills or any aqueous grinding apparatus.

In particular, the wet-grinding can be carried out in an agitator bead mill. The agitator bead mill comprises a grinding chamber containing a grinding medium as well as a stator and a rotor which are arranged in the grinding chamber. Preferably, the agitator bead mill comprises a grinding stock inlet opening and a grinding stock outlet opening for feeding and discharging ground material into and out of the grinding chamber, and a grinding medium separating device arranged in the grinding chamber upstream of the outlet opening in order to separate grinding medium particles from the grinding stock before the latter is discharged through the outlet opening from the grinding chamber.

In order to increase the mechanical grinding performance in the grinding chamber, pins are preferably present on the rotor and/or on the stator, which protrude into the grinding chamber. In operation, on the one hand, a direct contribution to grinding performance is provided by impacts between the material to be ground and the pins. On the other hand, a further contribution to the grinding performance takes place indirectly, by impacts between the pins and the grinding medium particles incorporated in the material to be ground and the then occurring impacts between the material to be ground and the grinding medium particles. Finally, shear forces and stretching forces acting on the material to be ground also contribute to the comminution of the suspended material to be ground.

Preferably, the final particle size of the fine calcium sulfate particles, i.e. the particle size after the wet-grinding process is less than 10.0 μm, more preferably less than 5.0 μm, still more preferably in the range of 0.1 to 2.0 μm, determined according to D (0.63) measured with laser diffraction (Mastersizer 2000 from Malvern Instruments) according to Mie Theory for small particles (Particle RI=1.531, Dispersant RI=1,.330; Absorption=0.1; Obscuration between 10 and 20%).

According to another embodiment of the present invention a process for the preparation of a construction chemical composition comprising fine calcium sulfate having a D (0.63) particle size of less than 10.0 μm determined with laser diffraction according to Mie Theory and a dispersant being a polyarylether, said process comprising the steps of
ba) providing a liquid A comprising a calcium source, water and optionally a dispersant being a polyarylether,
bb) providing a liquid B comprising a sulfate source, water and optionally a dispersant being a polyarylether, and
bc) precipitation of fine calcium sulfate by mixing liquid A and liquid B, thereby obtaining the construction chemical composition,

wherein the weight ratio between the fine calcium sulfate particles and the dispersant is in the range of 0.1:99.9 to 99.9:0.1.

The dispersant being a polyarylether is present in liquid A, liquid B or in both liquid A and B.

The calcium source in liquid A is selected from the group consisting of calcium acetate, calcium chloride, calcium hydroxide, calcium nitrate, calcium oxide, calcium sulfamate, calcium sulfate dihydrate, calcium sulfate hemihydrate, anhydrous calcium sulfate, calcium thiocyanate, or mixtures thereof.

The sulfate source in liquid B is selected from the group consisting of aluminum sulfate, potassium sulfate, sodium sulfate, sulfuric acid or mixtures thereof, in which the different hydrates of the sulfates named are included.

It is preferred that the polyarylether is a polycondensation product as described above.

Preferably, the precipitation according to step bc) is done in a continuous microreactor or a spray precipitation reactor.

In particular, the fine calcium sulfate can be precipitated according to step bc) by means of a microjet-reactor (MJR) process. A suitable process is described by DE102004038029. In particular, a mircrojet-reactor as described in EP 1 165 224 wherein precipitation is carried out by injecting two liquid media into a reactor chamber by means of pumps, preferably high-pressure pumps, is preferred. The reactor chamber is preferably enclosed by a reactor housing. The two liquid media are preferably injected to a shared collision point, each medium being injected through one nozzle. Through an opening in the reactor chamber a gas, an evaporating liquid, a cooling liquid or a cooling gas is preferably introduced so as to maintain the gas atmosphere in the reactor interior, notably in the collision point of the liquid jets, and to cool the resulting products. Furthermore, the gas is also beneficial for stabilizing the mixing area and to avoid clogging. The resulting products and excess gas are preferably removed from the reactor housing via a further opening by positive pressure on the gas input side or negative pressure on the product and gas discharge side.

The nozzles of the microjet-reactor (MJR) are not particularly limited with regard to their diameters. For example, the nozzles can independently have a diameter ranging from 50 μm to 1 mm, e.g. 50 μm, 100 μm, 150 μm, 200 μm, 250 μm, 300 μm, 350 μm, 400 μm 450 μm, 500 μm, 550 μm, 600 μm, 700 μm, 800 μm, 900 μm, or 1000 μm. Preferably, the nozzles have a diameter of 300 μm, i.e. diameters of 300 μm (liquid A) and 300 μm (liquid B). The polyarylether can be present in liquid A and/or in liquid B. Preferably, the polyarylether is present in liquid A.

Preferably, liquid A contains 0.1 to 60.0 wt.-% of a calcium source, more preferably 1.0 to 50.0 wt.-%, still more preferably 2.0 to 40.0 wt.-% and 0.0001 to 20.0 wt.-% of the polyarylether, more preferably 0.001 to 15.0 wt.-%, still more preferably 0.01 to 10.0 wt.-%, based on the overall weight of Feed 1.

Further, it is preferred that liquid B contains 0.1 to 60.0 wt.-% of the sulfate source, more preferably 1.0 to 50.0 wt.-%, still more preferably 2.0 to 40.0 wt.-% and optionally 0.0001 to 20.0 wt.-% of the polyarylether, more preferably 0.001 to 15.0 wt.-%, still more preferably 0.01 to 10.0 wt.-%, based on the overall weight of Feed 2.

It is preferred that the flow rate of liquid A and/or liquid B is in the range of 100 mL/min to 800 mL/min, preferably in the range of 200 mL/min to 650 mL/min, more preferably in the range of 250 mL/min to 550 mL/min, still more preferably in the range of 280 mL/min to 500 mL/min.

Further, it is preferred that liquid A and/or liquid B has/have and up-stream pressure in the range of 10 to 350 bar, preferably in the range of 20 to 150 bar, more preferably in the range of 30 to 120 bar, still more preferably in the range of 40 to 100 bar, e.g. 80 bar.

The suspension according to the invention can also be precipitated by means of a micronisation process. For instance, a suitable micronisation process is described in EP 0 065 193.

In a micronisation process, a composition comprising calcium sulfate, the dispersant being a polyarylether and a solvent is prepared in a first mixing chamber. Subsequently, said composition is precipitated in a second mixing chamber by addition of a further solvent.

According to a preferred embodiment, a suspension of the gypsum in a selected solvent is initially introduced into a first vessel. A second vessel preferably contains the solvent without admixed gypsum. The polyarylether may be present in the first vessel and/or the second vessel. The suspension and the solvent are fed to the first mixing chamber. Before it enters the mixing chamber, the gypsum suspension and/or the solvent can brought to a desired temperature by means of a heat exchanger. As a result of turbulent mixing in the first mixing chamber, dissolution of the gypsum occurs and the solution obtained passes, after a short residence time of preferably less than one second, into the second mixing chamber, where the gypsum is precipitated in a colloidally disperse form by admixture of a solvent.

Alternatively, the suspension according to the invention can be precipitated by means of a cross flow nozzle process. In a cross flow nozzle process, a first flow containing a suspension of gypsum and a solvent is fed into a mixing chamber while simultaneously, a second flow preferably arranged perpendicular to the first flow is fed into the mixing chamber, said second flow comprising a solvent. The dispersant being a polyarylether can be present in the first flow and/or in the second flow.

Further, the suspension according to the invention can be precipitated in accordance by means of the intensive mixture/spray precipitation technique (HTE). Said technique is well known in the art.

The present invention is further directed to the use of a polyarylether as a dispersant in a wet-grinding or precipitation process for the preparation of fine calcium sulfate.

Preferably, said polyarylether is a polycondensation product as described above.

Further, it is preferred that the construction chemical composition according to the invention is a powder with powder particles having a D (0.63) particle size of less than 500.0 μm, preferred <200 μm, more preferred <100 μm, determined by with laser diffraction according to Mie Theory.

The fine calcium sulfate particles according to the invention are embedded in the powder particles after drying.

The powder is produced in a step ac) or bd) by drying of a suspension containing the construction chemical composition according to the invention obtained in process step ab) or bc).

Accordingly, the powder is a composition comprising
i) fine calcium sulfate particles having a D (0.63) particle size of less than 10.0 μm determined by with laser diffraction according to Mie Theory, and
ii) a dispersant being a polyarylether,
   wherein the weight ratio between the fine calcium sulfate particles and the dispersant is in the range of 0.1:99.9 to 99.9:0.1

in accordance with the present invention.

Preferably, the weight ratio between the fine calcium sulfate particles and the dispersant within the powder is in the range of 60.0:40.0 to 99.0 to 1.0, more preferably in the range of 50.0 : 50.0 to 99.0: 1.0, still more preferably in the range of 80.0:20.0 to 98.0 to 2.0, like in the range of 85.0: 15.0 to 99.9:0.1. It is especially preferred that the weight ratio between the fine calcium sulfate particles and the dispersant is in the range of 85.0: 15.0 to 99.9:0.1.

Additionally or alternatively to the previous paragraph, it is preferred that the powder comprises
i) 0.1 to 99.9 wt.-%, more preferably 50.0 to 99.0 wt.-%, still more preferably 80.0 to 99.0 wt.-%, like 85.0 to 99.0 wt.-% of the fine calcium sulfate particles, and
ii) 0.1 to 99.9 wt.-%, more preferably 1.0 to 50.0 wt.-%, still more preferably 1.0 to 20.0 wt.-%, like 1.0 to 15.0 wt.-% of the dispersant being a polyarylether,

based on the overall weight of the powder.

Moreover, the powder may also comprise additives such as further dispersants other than polyarylethers, stabilizers and additives affecting the flow properties or the hardening process. Regarding said additives, reference is made to the definitions provided above.

Accordingly, the powder preferably comprises, more preferably consists of,
i) 70.0 to 99.9 wt.-%, more preferably 75.0 to 99.0 wt.-%, still more preferably 80.0 to 99.0 wt.-%, like 85.0 to 99.0 wt.-% of the fine calcium sulfate particles,
ii) 0.1 to 20.0 wt.-%, more preferably 1.0 to 18.0 wt.-%, still more preferably 1.0 to 15.0 wt.-%, like 1.0 to 12.0 wt.-% of the dispersant being a polyarylether
iii) optionally 0.01 to 6.0 wt.-%, more preferably 0.1 to 3.0 wt.-%, still more preferably 1.0 to 1.0 wt.-% of at least one dispersant other than polyarylethers,
iv) optionally 0.01 to 3.0 wt.-%, more preferably 0.1 to 2.0 wt.-%, still more preferably 0.2 to 1.0 wt.-% of a stabilizer, and
v) optionally up to 1.0 wt.-%, more preferably 0.01 to 2.0 wt.-%, still more preferably 0.1 to 1.0 wt.-% of additives, based on the overall weight of the powder.

It was further surprising that dried accelerator of the invention showed higher storage stability as state-of-the-art gypsum-based accelerators produced by dry milling process in presence of starch, surfactant and/or sugar. Accelerating properties of dry milled gypsum-based accelerators become significant worse, especially after storage at high humidity. This is not the case for dried accelerator of the present invention. Thus, also dry mortars comprising the powder have a very good storage stability. Preferred dry mortar mixtures are containing calcium sulfate as binder component and are applied as e.g. plasters, joint fillers, joint grouts, screeds or self-levelling underlayment.

The present invention is also directed to an article comprising the above described construction chemical composition.

Preferably, the article is selected from the group consisting of gypsum wallboard, non-woven gypsum board, stucco, mortar plaster, machine compliant plaster, plaster gypsum, adhesive plaster, joints gypsum, gypsum based filler, screed gypsum, finish plaster and marble plaster.

It is especially preferred that the article is a gypsum wallboard.

Accordingly, the present invention is also directed to the use of the above described construction chemical composition in a process for preparing a gypsum wallboard. Methods for preparing gypsum wallboards are well known in the art and typically include the preparation of a foamed gypsum slurry which is subsequently applied to a cardboard sheet.

Thus, it is preferred that the process comprises the steps of
ca) providing a composition comprising gypsum, mixing water and optionally foam,
cb) feeding the composition obtained in step ca) into a mixing device, thereby preparing a slurry,
cc) applying the slurry obtained in step cb) to a first cardboard sheet, and
cd) covering the slurry with a second cardboard sheet.

The construction chemical composition can be added to the slurry during step ca), cb), cc) and/or cd). In particular, the mixing water and/or the foam added to the composition according to step ca) may contain the construction chemical composition. The construction chemical composition can also be applied to the first and/or second cardboard sheet prior to steps cc) and cd).

Additionally or alternatively, the construction chemical composition can be added directly to the slurry in the mixing device during step cb) and/or through a feed valve at the outlet of the mixing device.

Accordingly, at least one of the mixing water, the foam, contains the construction chemical composition, and/or the construction chemical composition is added to the slurry in the mixing device or through a feed valve at the outlet of the mixing device.

Additionally or alternatively to the previous paragraph, the first cardboard sheet and/or the second cardboard sheet is coated with the construction chemical composition.

Suitable methods for dosing the construction chemical composition are, for example, described in US2015114268A, WO06115497A1, US2006244182A and US2006244183A.

Further the present invention is also directed to the use of the above described construction chemical composition in a process for preparing a gypsum containing dry mortar, non-woven gypsum board, stucco, mortar plaster, machine compliant plaster, plaster gypsum, adhesive plaster, joints gypsum, gypsum based filler, screed gypsum, finish plaster and marble plaster. In a preferred embodiment the construction chemical composition is used to enhance the compressive strength of the prepared article.

The compressive strength of the prepared article is enhanced after 10 minutes, 30 minutes, 60 minutes and preferably after mass consistency of calcium sulfate based article according to DIN 196-1 for investigation on strength development.

The scope and interest of the invention will be better understood based on the following examples which are intended to illustrate certain embodiments of the invention and are non-limitative.

### EXAMPLES

Used materials

The polyarylether (PAE) used in the inventive composition IE1 is comparative example 7 of WO 2015/091461 A1.

The polycarboxylate used in the comparative composition CE1 is the commercial product Me!flux PCE 239 L by BASF.

The polycarboxylate used in the comparative composition CE2 is the commercial product Me!flux PCE 1493 L by BASF

The poly-naphthalene sulfonate (PNS) used in different compositions is the commercial product Flube CA 40 by Bozzetto.

β-hemihydrate is the commercial product Gesso Alabastrino by Gessi Roccastrada having an average particle size of 40 μm.

Natural anhydrite is the commercial product Micro B by Casea having an average particle size of 35 μm.

Dihydrate is the commercial product CS-Dihydrat by Casea having an average particle size of 50 μm.

Plast Retard L is the commercial product by Sicit 2000.

Preparation of the slurries

### Reference Example 1

As a reference, a blank gypsum slurry not containing any accelerator was produced using 300 g of β-hemihydrate. The quantity of water needed corresponding to a water-to-binder (w/g) ratio of 0.665 and determined on the basis of the untreated gypsum slurry is charged into a mixing vessel (mixer according to DIN EN 196-1) and then the β-hemihydrate is sprinkled carefully into the water. Further, Plast Retard L in amounts as indicated in Table 1 is added to the mixing water. The slurry was stirred for 30 seconds at 285 rpm. Water-to-binder (w/g) ratio of 0.665 was adjusted to achieve a flow of 21.0 cm for reference example 1.

### Comparative Examples CE1 and CE2

Preparation of the liquid accelerator

For the preparation of the liquid accelerator, a composition of 15 wt.-% dihydrate, 83 wt.-% water and 2.0 wt.-% PCE was subjected to wet-grinding on a Netzsch Labstar LS 01 using zirconium oxide balls in diameter of 0.4-0.6 mm and wetted area of 85%. Wet-grinding was carried out for a total of 240 min.

Application Test

Slurries were produced using 300 g of β-hemihydrate. The quantity of water needed corresponding to a water-to-binder (w/g) ratio of 0.665 and determined on the basis of the untreated gypsum slurry is charged into a mixing vessel (mixer according to DIN EN 196-1) and then the β-hemihydrate is sprinkled carefully into the water. The Plast Retard L was added to the mixing water in amounts as indicated in Table 1. During mixing, the liquid accelerator was dosed by injection. The slurry was stirred for 30 seconds at 285 rpm.

### Comparative Example CE3

Preparation of the Liquid Accelerator

For the preparation of the liquid accelerator, a composition of 15 wt.-% dihydrate and 83 wt.-% water was subjected to wet-grinding on a Netzsch Labstar LS 01 using zirconium oxide balls in diameter of 0.4-0.6 mm and wetted area of 85%. Wet-grinding was carried out for a total of 240 min.

Application Test

A slurry was produced using 300 g of β-hemihydrate. The quantity of water needed corresponding to a water-to-binder (w/g) ratio of 0.665 and determined on the basis of the untreated gypsum slurry is charged into a mixing vessel (mixer according to DIN EN 196-1) and then the β-hemihydrate is sprinkled carefully into the water. The Plast Retard L was added to the mixing water in amounts as indicated in Table 1. During mixing, the liquid accelerator was dosed by injection. The slurry was stirred for 30 seconds at 285 rpm.

### Comparative Example CE4

Preparation of the Dry Accelerator

For comparative purposes, a dry accelerator was prepared by subjecting dihydrate having a particle size of 5 μm in amounts as indicated in Table 1 was subjected by dry grinding of dihydrate with 5% of alkylbenzene sulfonic acid, amine salt in a ball mill for a total of 4 min.

Application Test

A slurry was produced using 250 g of β-hemihydrate and 0.05 g (0.02% bws) dry accelerator. The quantity of water needed corresponding to a water-to-binder (w/g) ratio of 0.685 and determined on the basis of the untreated gypsum slurry is charged into a mixing vessel (mixer according to DIN EN 196-1) and then the β-hemihydrate including the dry accelerator is sprinkled carefully into the water. The Plast Retard L was added to the mixing water in amounts as indicated in Table 1. The slurry was stirred tor 30 seconds at 285 rpm. Water-to-binder (w/g) ratio of 0.665 was adjusted to achieve a flow of 21.0 cm for comparative example CE4.

### Inventive examples IE1, IE2 and IE3

Preparation of the Liquid Accelerator

For the preparation of the liquid accelerator, a composition of dihydrate, water and PAE in amounts as indicated in Table 1 was subjected to wet-grinding on a Netzsch Labstar LS 01 using zirconium oxide balls in diameter of 0.4-0.6 mm and wetted area of 85%. Wet-grinding was carried out for a total of 240 min.

Application Test

The inventive slurries were produced using 300 g of β-hemihydrate. The quantity of water needed corresponding to a water-to-binder (w/g) ratio of 0.665 and determined on the basis of the untreated gypsum slurry is charged into a mixing vessel (mixer according to DIN EN 196-1) and then the β-hemihydrate is sprinkled carefully into the water. The Plast Retard L was added to the mixing water in amounts as indicated in Table 1. During mixing, the respective liquid accelerator was dosed by injection. The slurry was stirred for 30 seconds at 285 rpm.

### Inventive Example IE4

Preparation of the Liquid Accelerator

For the preparation of the liquid accelerator, a composition of hemihydrate, water and PAE in amounts as indicated in Table 1 was subjected to wet-grinding on a Netzsch Labstar LS 01 using zirconium oxide balls in diameter of 0.4-0.6 mm and wetted area of 85%. Wet-grinding was carried out for a total of 240 min.

Application Test

A slurry was produced using 250 g of β-hemihydrate. The quantity of water needed corresponding to a water-to-binder (w/g) ratio of 0.685 and determined on the basis of the untreated gypsum slurry is charged into a mixing vessel (mixer according to DIN EN 196-1) and then the β-hemihydrate is sprinkled carefully into the water. The Plast Retard L was added to the mixing water in amounts as indicated in Table 1. During mixing, the liquid accelerator was dosed by injection. The slurry was stirred for 30 seconds at 285 rpm.

### Inventive Example IE5

Preparation of the Liquid Accelerator

For the preparation of the liquid accelerator, a composition of natural anhydrite, water and PAE in amounts as indicated in Table 1 was subjected to wet-grinding on a Netzsch Labstar LS 01 using zirconium oxide balls in diameter of 0.4-0.6 mm and wetted area of 85%. Wet-grinding was carried out for a total of 240 min.

Application Test

A slurry was produced using 250 g of natural anhydrite. The quantity of water needed corresponding to a water-to-binder (w/g) ratio of 0.685 and determined on the basis of the untreated gypsum slurry is charged into a mixing vessel (mixer according to DIN EN 196-1) and then the β-hemihydrate is sprinkled carefully into the water. The Plast Retard L was added to the mixing water in amounts as indicated in Table 1. During mixing, the liquid accelerator was dosed by injection. The slurry was stirred for 30 seconds at 285 rpm.

The compositions of the liquid accelerators are summarized in Table 1. Table 2 contains the composition and properties of application examples containing the liquid accelerators.

Particle Size

The particle size was determined with laser diffraction (Mastersizer 2000 from Malvern Instruments) according to Mie Theory for small particles (Particle RI=1.531, Dispersant RI=1,.330; Absorption=0.1; Obscuration between 10 and 20%).

The results are summarized in Table 2.

Slump Test

Flow was determined after a time of 60 seconds. After adding powder components to liquid the stucco had to soak for 15 seconds. Then the slurry was mixed for 30 seconds with a Hobart mixer. After a total time of 45 seconds an ASTM ring was filled with the stucco slurry up to the top edge and lifted after 60 seconds. At the end the patty diameter was measured with a caliper rule on two perpendicular axes.

Hardening Time

Initial setting was determined with the so-called knife-cut method (analogous to DIN EN 13279-2).

2). The results are summarized in Table 2.

As can be gathered from Table 2, the hardening times of the inventive compositions containing

PAE as dispersant for liquid accelerator are significantly lower than the hardening time of the reference example containing no dispersant for liquid accelerator. Compared to examples CE1 and CE2 containing PCE as dispersant, the hardening times of examples IE1 and IE2 containing the same amount of PAE are also lower. The effect of the inventive dispersant is also shown for hemihydrate (IE4) and natural anhydrite (IE5) as gypsum components. Example CE4 shows that the hardening time and, therefore, the particle size of fine calcium sulfate obtained from the inventive wet-grinding process is superior to that of fine calcium sulfate obtained by a dry grinding method.

TABLE 1
Composition of the comparative and inventive construction chemical compositions

| | | Ref1 | IE1 | CE1 | CE2 | IE2 | IE3 | CE3 | IE4 | IE5 |
|---|---|---|---|---|---|---|---|---|---|---|
| Dihydrate | [wt.-%] | — | 15 | 15 | 15 | 35 | 15 | 15 | | |
| Hemihydrate | | | | | | | | | 25 | |
| Natural Anhydrite | | | | | | | | | | 25 |
| Solids content | [wt.-%] | — | 17 | 17 | 17 | 37 | 15.1 | 15 | 25.5 | 25.5 |
| Water content | [wt.-%] | | 83 | 83 | 83 | 63 | 84.9 | 85 | 74.5 | 74.5 |
| PAE | [wt.-%] | — | 2.0 | — | — | 2.0 | 0.1 | — | 0.5 | 0.5 |
| PCE | [wt.-%] | — | | 2.0 | 2.0 | | | — | | |

TABLE 2
Composition and properties of the application examples containing
the comparative and inventive construction chemical compositions

| | | Ref1 | IE1 | CE1 | CE2 | IE2 | IE3 | CE3 | IE4 | IE5 | CE4 |
|---|---|---|---|---|---|---|---|---|---|---|---|
| Hemihydrate (Binder) | [g] | 300 | 300 | 300 | 300 | 300 | 300 | 300 | 250 | 250 | 250 |
| H₂O/Hemihydrate | [—] | 0.665 | 0.665 | 0.665 | 0.665 | 0.665 | 0.665 | 0.665 | 0.685 | 0.685 | 0.685 |
| Dry Powder Ball Mill | [% bws] | | | | | | | | | | 0.02 |
| Accelerator | | | | | | | | | | | |
| Liquid Accelerator (active | [% bws] | 0.00 | 0.02 | 0.02 | 0.02 | 0.02 | 0.02 | 0.02 | 0.02 | 0.02 | 0.00 |
| matter) | | | | | | | | | | | |
| Plast Retard L (1% Ig) | [g] | 2.0 | 2.0 | 2.0 | 2.0 | 2.0 | 2.0 | 2.0 | 1.5 | 1.5 | 1.5 |
| Particle size, D(0.63) | [μm] | — | 0.75 | 0.60 | 0.97 | 0.69 | 0.55 | 2.48 | 0.82 | 1.62 | 69.55 |
| Stiffening time | [min:s] | 18:20 | 2:10 | 2:50 | 2:40 | 2:00 | 3:15 | 6:05 | 2:20 | 2:25 | 3:50 |

Mechanical Properties

For determining the flexural strength and compressive strength of gypsum articles prepared from the above described slurries, test specimens were prepared as follows:

The weight and density of said test specimens prepared at seed dosages of 0.02% and 0.01% are summarized in Tables 3 and 4.

Test specimens (4×4×16 cm³ prism) were prepared according to DIN 196-1 for investigation on strength development. Before testing flexural and compressive strength all samples were dried until mass consistency in the following way. After setting of the gypsum slurry all test specimens were stored at 20° C./65% relative humidity for one day. Afterwards all samples were stripped of the molds and then dried at 40° C. until mass consistency. Dry density was calculated by weighing and by volume (256 cm³). Tables 3 and 4 contain the result of different measurements of the flexural strength and compressive strength and the average values thereof.

TABLE 3
Mechanical properties (seed dosage: 0.02%)

| | | Ref1 | IE1 | CE1 | CE2 |
|---|---|---|---|---|---|
| Prism weight | [g] | 605.74 | 586.62 | 585.29 | 587.44 |
| Density | [kg/dm³] | 1.183 | 1.146 | 1.143 | 1.147 |
| Flexural strength | [N/mm²] | 5.280 | 7.105 | 7.240 | 7.040 |
| Compressive strength | [N/mm²] | 20.70 | 24.70 | 21.40 | 22.10 |
| (1) | | | | | |
| Compressive strength | [N/mm²] | 19.60 | 23.50 | 22.28 | 22.20 |
| (average) | | | | | |

TABLE 4
Mechanical properties (seed dosage: 0.01%)

| | | IE1 | CE1 | CE2 | IE3 | CE3 |
|---|---|---|---|---|---|---|
| Prism weight | [g] | 585.52 | 584.40 | 584.16 | 584.98 | 591.01 |
| Density | [kg/dm³] | 1.144 | 1.141 | 1.141 | 1.143 | 1.154 |
| Flexural strength | [N/mm²] | 7.460 | 6.910 | 6.545 | 6.410 | 6.040 |
| Compressive strength | [N/mm²] | 23.70 | 21.78 | 21.43 | 17.20 | 15.85 |

According to Table 3, the flexural strength and compressive strength of the compositions prepared in the presence of a dispersant are improved compared to the blank reference. The compressive strength of the resulting gypsum article containing PAE are improved compared to the compositions containing PCE. Thus, the application of PAE instead of PCE according to the inventive wet-grinding process has a beneficial effect on the compressive strength of the resulting gypsum article.

1.-16. (canceled)

17. A construction chemical composition, comprising
i) fine calcium sulfate particles having a D (0.63) particle size of less than 10.0 μm determined with laser diffraction according to Mie Theory, and
ii) a dispersant being a polyarylether,
wherein the weight ratio between the fine calcium sulfate particles and the dispersant is in the range of 0.1:99.9 to 99.9:0.1.

18. A construction chemical composition according to claim 17, wherein the fine calcium sulfate particles are present in the form of calcium sulfate hemihydrate, calcium sulfate dihydrate, anhydrous calcium sulfate or mixtures thereof.

19. A construction chemical composition according to claim 17, wherein the polyarylether is a polycondensation product comprising
i) at least one aromatic or heteroaromatic structural unit comprising a polyether side chain, and
ii) at least one phosphated aromatic or heteroaromatic structural unit.

20. A construction chemical composition according to claim 19, wherein the at least one aromatic or heteroaromatic structural unit comprising a polyether side chain is represented by formula (I) 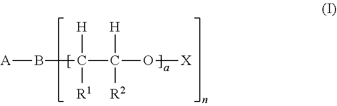
wherein
A are identical or different and are represented by a substituted or unsubstituted aromatic or heteroaromatic compound having 5 to 10 C atoms;
B are identical or different and are represented by N, NH or O;
n=2 if B=N and n=1 if B=NH or O;
R¹ and R², independently of one another, are identical or different and are represented by a branched or straight-chain C1- to C10-alkyl radical, C5- to C8-cycloalkyl radical, aryl radical, heteroaryl radical or H;
a are identical or different and are represented by an integer from 1 to 300; and
X are identical or different and are represented by a branched or straight-chain C1- to C10-alkyl radical, C5- to C8-cycloalkyl radical, aryl radical, heteroaryl radical or H,
and wherein
the at least one phosphated aromatic or heteroaromatic structural unit is represented by formula (II) 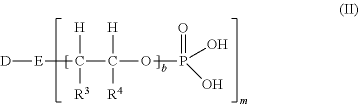
wherein
D are identical or different and are represented by a substituted or unsubstituted aromatic or heteroaromatic compound having 5 to 10 C atoms;
E are identical or different and are represented by N, NH or O;
m=2 if E=N and m=1 if E=NH or O;
R³ and R⁴, independently of one another, are identical or different and are represented by a branched or straight-chain C1- to C10-alkyl radical, C5- to C8-cycloalkyl radical, aryl radical, heteroaryl radical or H; and
b are identical or different and are represented by an integer from 0 to 300.

21. A process for the preparation of a construction chemical composition comprising fine calcium sulfate having a D (0.63) particle size of less than 10.0 um determined with laser diffraction according to Mie Theory and a dispersant being a polyarylether, said process comprising the steps of
aa) providing a suspension comprising calcium sulfate particles having a D (0.63) particle size equal or above 10.0 um determined with laser diffraction according to Mie Theory, water and a dispersant being a polyarylether, and
ab) wet-grinding of the slurry obtained in step aa), thereby obtaining the construction chemical composition,
wherein the weight ratio between the fine calcium sulfate particles and the dispersant is in the range of 0.1:99.9 to 99.9:0.1.

22. A process according to claim 21, wherein the calcium sulfate particles are present in the form of calcium sulfate hemihydrate, calcium sulfate dihydrate, anhydrous calcium sulfate or mixtures thereof.

23. A process according to claim 21, wherein the suspension of step aa) comprises
i) 0.07 to 70.0 wt.-% of gypsum,
ii) 0.01 to 10.0 wt.-% of the dispersant being a polyarylether, and
iii) the balance to 100 wt.-% being water,
based on the overall weight of the suspension.

24. A process according to claim 21, wherein the wet-grinding according to step ab) is carried out in a ball mill, a rotary grinder or an agitator bead mill.

25. A process for the preparation of a construction chemical composition comprising fine calcium sulfate having a D (0.63) particle size of less than 10.0 μm determined with laser diffraction according to Mie Theory and a dispersant being a polyarylether, said process comprising the steps of
ba) providing a liquid A comprising a calcium source, water and a dispersant being a polyarylether,
bb) providing a liquid B comprising a sulfate source, water and optionally a dispersant being a polyarylether, and
bc) precipitation of fine calcium sulfate by mixing liquid A and liquid B, thereby obtaining the construction chemical composition,
wherein the weight ratio between the fine calcium sulfate particles and the dispersant is in the range of 0.1:99.9 to 99.9:0.1.

26. A process according to claim 25, wherein the precipitating according to step bc) is carried out in a continuous microreactor or a spray precipitation reactor.

27. A process according to claim 21, wherein the process further comprises a step ac) or bd) wherein the construction chemical composition obtained in step ab) or bc) is dried, thereby obtaining the construction chemical composition in powder form.

28. A process according to claim 21, wherein the polyarylether is a polycondensation product according to claim 19.

29. A method comprising utilizing the construction chemical composition according to claim 17 in a process for preparing a gypsum wallboard, said process comprising the steps of
ca) providing a composition comprising gypsum, mixing water and optionally foam,
cb) feeding the composition obtained in step ca) into a mixing device, thereby preparing a slurry,
cc) applying the slurry obtained in step cb) to a first cardboard sheet, and
cd) covering the slurry with a second cardboard sheet, wherein
i) at least one of the mixing water and the foam contains the construction chemical composition, and/or
ii) ii) the first cardboard sheet and/or the second cardboard sheet is coated with the construction chemical composition, and/or
iii) the construction chemical composition is added to the slurry in the mixing device or through a feed valve at the outlet of the mixing device.

30. A method comprising utilizing a polyarylether as a dispersant in a wet-grinding or precipitation process for the preparation of fine calcium sulfate particles having a D (0.63) particle size of less than 10.0 um determined with laser diffraction according to Mie Theory.

31. Article, made by using the composition according to claim 17.

32. Article according to claim 31, wherein the article is selected from a gypsum wallboard, a non-woven gypsum board, a gypsum-based self-levelling underlayment, a joint filler, a plaster, a mold, or a floor screed.
